(19) United States
(12) Patent Application Publication
(10) Pub. No.: US 2009/0143190 A1
(43) Pub. Date: Jun. 4, 2009

(54) TRANSMISSION SYSTEM FOR ALL-TERRAIN VAN

(76) Inventor: Yin-Hsin Chen, Taichung City (TW)

Correspondence Address: Dr. BANGER SHIA;Int''l Patent Office of Bang Shia, 102 Lindencrest Ct, Sugar Land, TX, 77479-5201, US

(21) Appl. No.: 11/948,136

(22) Filed: Nov. 30, 2007

(51) Int. Cl. B60W 10/10; B60W 10/18

(52) U.S. Cl. 477/40

(57) ABSTRACT

A transmission system includes a power transmission mechanism mounted on a chassis of an all-terrain van and front and rear wheel mechanism mounted on the chassis of the all-terrain van. The power transmission mechanism includes an engine mounted on the chassis in a transverse direction of the chassis. The engine includes a continuously variable transmission system and an output shaft extending toward the rear wheel mechanism. The power transmission mechanism further includes a transmission shaft extending between the engine and the rear wheel mechanism. The transmission shaft includes a first end in direct coupling with the output shaft of the engine and a second end coupled with a gearbox of the rear wheel mechanism such that output of the engine drives the output shaft, the transmission shaft, and the rear wheel mechanism. Thus, the transmission loss is reduced, and the transmission efficiency is enhanced.

### BACKGROUND OF THE INVENTION

1. Field of the Invention

The present invention relates to a transmission system for an all-terrain van with enhanced transmission efficiency and enhanced braking effect.

2. Description of the Related Art

A typical all-terrain van includes a chassis, a power transmission mechanism, a steering mechanism, and front and rear wheel mechanisms. The power transmission mechanism generally includes an engine and transmission parts to provide power transmission through a chain or a shaft. FIG. 5 shows an all-terrain van utilizing a chain to proceed with power transmission. Specifically, the all-terrain van includes an engine 11′ with a continuously variable transmission system mounted on a chassis 12′ in the longitudinal direction of the chassis 12′. An output shaft 111′ of the engine 11′ is connected by a chain 13′ to a rear wheel mechanism 14′ so that the rear wheel mechanism 14′ can be driven by the output shaft 111′ to move the van through the chain 13′ and the rear wheel mechanism 14′. However, the chain 13′ causes considerable loss in transmission efficiency, torque, and horsepower as well as loud noise and is liable to be disengaged and damaged.

FIG. 6 shows another conventional all-terrain van including an engine 21′ with a continuously variable transmission system mounted on a chassis 22′ in the longitudinal direction of the chassis 22′. A bevel gear 212′ is provided on an output shaft 211′ of the engine 21′. Provided on a front end of a transmission shaft 23′ is a bevel gear 231′ meshed with and perpendicular to the bevel gear 212′. A rear end of the transmission shaft 23′ is connected to a rear wheel mechanism 24′. Thus, the rear wheel mechanism 24′ can be driven by the output shaft 211′ to move the van through the transmission shaft 23φ and the rear wheel mechanism 24′. However, the bevel gears 212′ and 231′ increase the loss in transmission efficiency, torque, and horsepower.

Furthermore, conventional all-terrain vans generally include a braking mechanism on the axle of the rear wheel mechanism. The braking mechanism has a braking point at a distal end of the transmission mechanism such that a larger braking force is required to stop the axle, leading to unsatisfactory braking effect.

### BRIEF SUMMARY OF THE INVENTION

An objective of the present invention is to provide an all-terrain van with improved transmission efficiency as well as improved braking effect.

A transmission system for an all-terrain van according to the preferred teachings of the present invention includes a power transmission mechanism adapted to be mounted on a chassis of an all-terrain van and front and rear wheel mechanism adapted to be mounted on the chassis of the all-terrain van. The power transmission mechanism includes an engine adapted to be mounted on the chassis in a transverse direction of the chassis. The engine includes a continuously variable transmission system and an output shaft extending toward the rear wheel mechanism. The power transmission mechanism further includes a transmission shaft extending between the engine and the rear wheel mechanism. In a preferred form, the transmission shaft includes a first end in direct coupling with the output shaft of the engine and a second end coupled with a gearbox of the rear wheel mechanism such that output of the engine drives the output shaft, the transmission shaft, and the rear wheel mechanism. Thus, the transmission loss is reduced, and the transmission efficiency is enhanced.

A braking mechanism can be mounted between the transmission shaft and the gearbox of the rear wheel mechanism. The braking mechanism includes a disc and a braking device operable to clamp the disc to thereby brake the transmission shaft and the rear wheel mechanism. Since the braking mechanism is located at a front portion of the transmission system, the braking effect is enhanced.

The engine can further include another output shaft facing the front wheel mechanism. The power transmission mechanism can further include another transmission shaft having a first end in direct coupling with the other output shaft and a second end connected to the front wheel mechanism such that the output of the engine drives the other output shaft, the other transmission shaft, and the front wheel mechanism. Namely, the front and rear wheel mechanisms are directly driven by the output shafts, providing four-wheel transmission to reduce transmission loss and to enhance transmission efficiency.

Front and rear suspension mechanisms can be provided to the front and rear wheel mechanisms and coupled with the chassis. The transmission system according to the preferred teachings of the present invention can be utilized with a chassis with four-wheel independent suspension to provide better transmission efficiency and better driving stability.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a diagrammatic top view of an all-terrain van with a transmission system of a first embodiment according to the preferred teachings of the present invention.

FIG. 2 shows a diagrammatic side view of the all-terrain van of FIG. 1.

FIG. 3 shows a diagrammatic top view of an all-terrain van with a transmission system of a second embodiment according to the preferred teachings of the present invention.

FIG. 4 shows a diagrammatic side view of the all-terrain van of FIG. 3.

FIG. 5 shows a diagrammatic top view of a transmission system of a conventional all-terrain van.

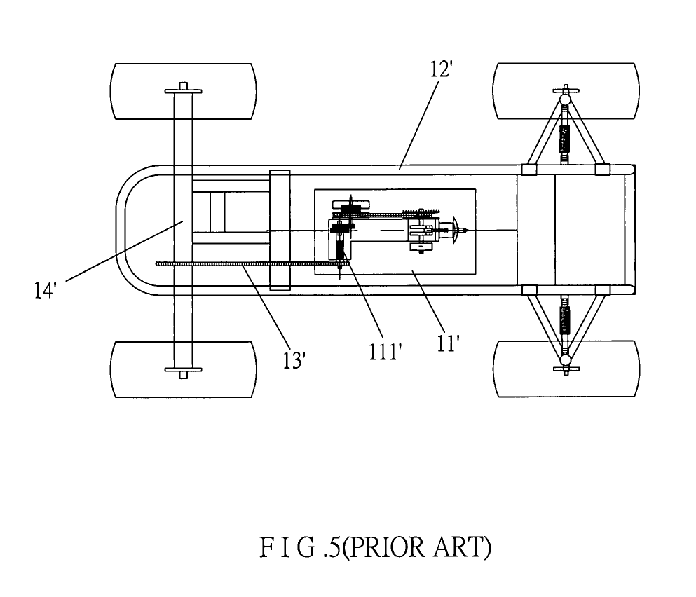

FIG. 6 shows a diagrammatic top view of a transmission system of another conventional all-terrain van.

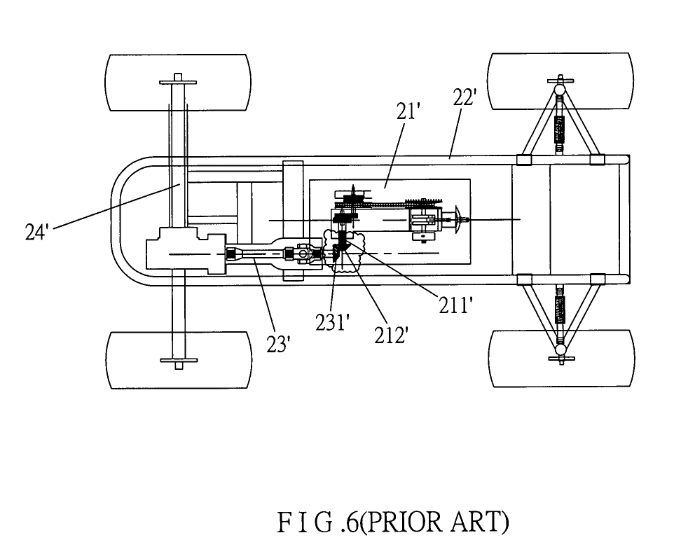

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

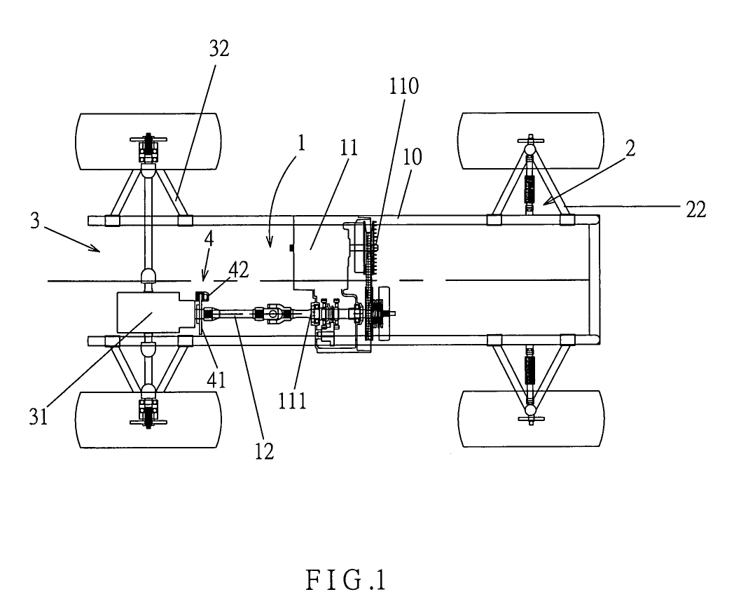

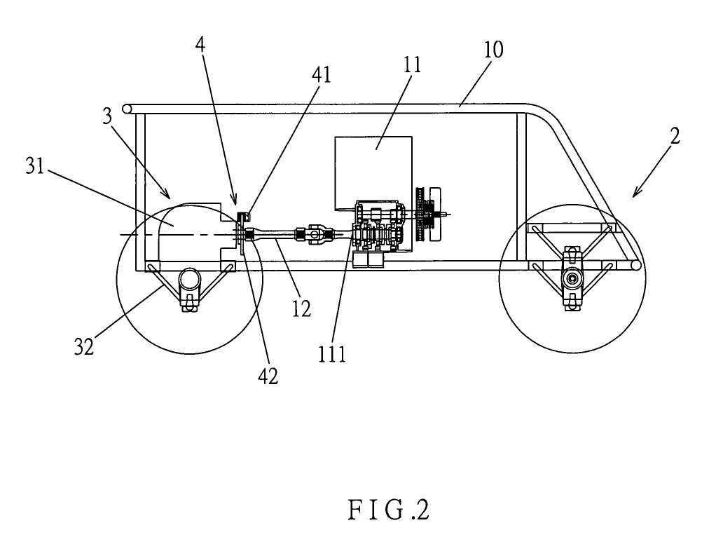

With reference to FIGS. 1 and 2, a transmission system of a first embodiment according to the preferred teachings of the present invention is mounted on a chassis 10 of an all-terrain van and includes a power transmission mechanism 1 and front and rear wheel mechanisms 2 and 3. The power transmission mechanism 1 includes a continuously variable transmission (CVT) type engine 11 and a transmission shaft 12. The engine 11 is mounted to the chassis 10 in a transverse direction of the chassis 10 and includes a CVT system 110 extending in the transverse direction of the chassis 10. The engine 11 further includes an output shaft 111 extending toward the rear wheel mechanism 3.

The transmission shaft 12 is provided between the engine 11 and the rear wheel mechanism 3 in a longitudinal direction of the chassis 10 perpendicular to the transverse direction. An end of the transmission shaft 12 is in direct coupling with the output shaft 111 of the engine 11. The other end of the transmission shaft 12 is connected to a gear box 31 of the rear wheel mechanism 3. Thus, the output of the engine 11 drives the transmission shaft 12 to turn and causes operation of the rear wheel mechanism 3 with reduced transmission loss and enhanced transmission efficiency.

Front and rear suspension mechanisms 22 and 32 are provided to front and rear wheel mechanisms 2 and 3 and coupled with the chassis 10, providing buffering effect in response to rugged surfaces when the van runs through various terrains. Driving stability is, thus, enhanced. It can be appreciated that the transmission system according to the preferred teachings of the present invention can be utilized with a chassis with four-wheel independent suspension to provide better transmission efficiency and better driving stability.

A braking mechanism 4 is mounted between the transmission shaft 12 and the gearbox 31 of the rear wheel mechanism 3. The braking mechanism 4 includes a disc 41, a braking device 42 that can be operated to clamp the disc 41 to thereby brake the transmission shaft 12 and the rear wheel mechanism 3. Since the braking mechanism 4 is located at a front portion of the power transmission parts, the braking effect is enhanced.

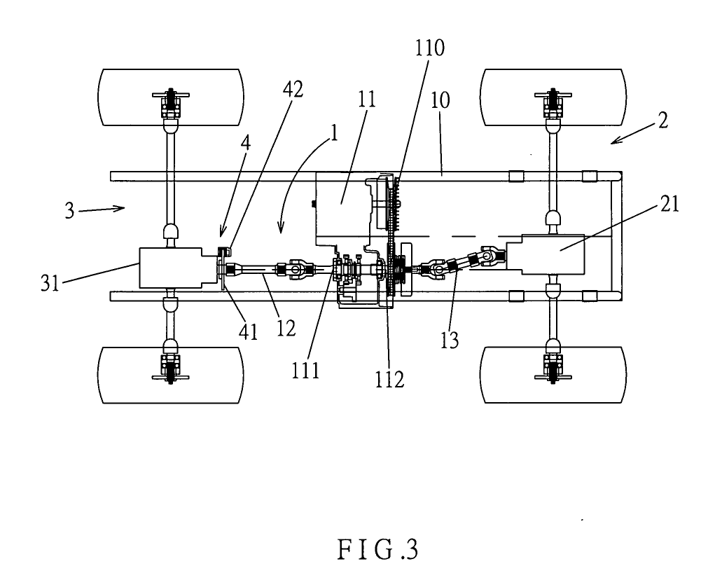

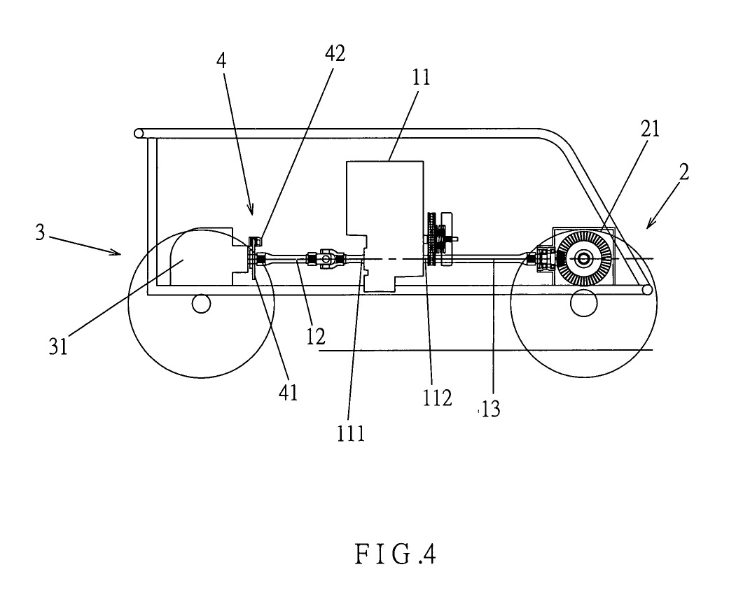

FIGS. 3 and 4 show a transmission system of a second embodiment according to the preferred teachings of the present invention. In this embodiment, the CVT engine 11 includes a front output shaft 112 cooperating with the front wheel mechanism 2 and a rear output shaft 111 extending toward and cooperating with the rear wheel mechanism 3. The structure and transmission with regard to the rear wheel mechanism 3 are identical to those of the first embodiment. Furthermore, a transmission shaft 13 is provided between the front output shaft 112 and a gearbox 21 of the front wheel mechanism 2. Thus, the output of the engine 11 causes rotation of the front and rear output shafts 112 and 111 to drive the front and rear wheel mechanisms 2 and 3, providing four-wheel transmission. The transmission loss is reduced, and the transmission efficiency is enhanced. Such an all-terrain van has enhanced performance on off-roads. Thus, the transmission system according to the preferred teachings of the present invention can be utilized with a chassis with four-wheel transmission to provide better transmission efficiency and better off-road performance.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A transmission system for an all-terrain van comprising:
a power transmission mechanism adapted to be mounted on a chassis of an all-terrain van, with the power transmission mechanism including an engine adapted to be mounted on the chassis in a transverse direction of the chassis, with the engine including a continuously variable transmission system and an output shaft, with the power transmission mechanism further including a transmission shaft; and
front and rear wheel mechanism adapted to be mounted on the chassis of the all-terrain van:
with the output shaft of the engine extending toward the rear wheel mechanism, and
with the transmission shaft extending between the engine and the rear wheel mechanism and including a first end in direct coupling with the output shaft of the engine and a second end coupled with the rear wheel mechanism such that output of the engine drives the output shaft, the transmission shaft, and the rear wheel mechanism.

2. The transmission system for an all-terrain van as claimed in claim 1, with the rear wheel mechanism further including a gearbox coupled with the second end of the transmission shaft, and with the transmission system further comprising, in combination: a braking mechanism mounted between the transmission shaft and the gearbox of the rear wheel mechanism.

3. The transmission system for an all-terrain van as claimed in claim 2, with the braking mechanism including a disc and a braking device operable to clamp the disc to thereby brake the transmission shaft and the rear wheel mechanism.

4. The transmission system for an all-terrain van as claimed in claim 1, with the engine further including another output shaft extending toward the front wheel mechanism, and with the power transmission mechanism further including another transmission shaft including a first end in direct coupling with the other output shaft and a second end connected to the front wheel mechanism such that the output of the engine drives the other output shaft, the other transmission shaft, and the front wheel mechanism.
